(19) United States
(12) Patent Application Publication
(10) Pub. No.: US 2010/0109830 A1
(43) Pub. Date: May 6, 2010

(54) TRANSFORMER

(76) Inventor: Volker W. Hanser, Kehl (DE)

Correspondence Address: CARLSON, GASKEY & OLDS, P.C., 400 WEST MAPLE ROAD, SUITE 350, BIRMINGHAM, MI, 48009, US

(21) Appl. No.: 12/524,637

(22) PCT Filed: Feb. 1, 2008
(86) PCT No.: PCT/EP08/00835

§ 371 Date: Jul. 27, 2009

(30) Foreign Application Priority Data
Feb. 7, 2007 (DE) 10 2007006 005.1

(51) Int. Cl. H01F 27/32; H01B 17/42

(52) U.S. Cl. 336/206; 174/140 R

(57) ABSTRACT

A transformer includes an upper-voltage winding and a lower-voltage winding for potential separation. An insulation arrangement is disposed between the upper-voltage winding and the lower-voltage winding. The insulation arrangement includes a layer structure having an inner insulation, at least one semiconducting layer adjacent to the inner insulation, and an electrically conducting layer adjacent to the at least one semiconducting layer and having a defined potential applied thereto that is at least about equal to a lower voltage of the lower-voltage winding.

### RELATED APPLICATION

This application is the U.S. National Phase of PCT/EP2008/000835, which was filed Feb. 1, 2008, which claimed priority to DE 10 2007 006 005.1, which was filed Feb. 7, 2007.

### BACKGROUND OF THE INVENTION

The present disclosure relates to a transformer, such as a high voltage transformer, having a voltage insulation between an upper-voltage winding and a lower-voltage winding for potential separation.

High-voltage transformers are necessary to match different voltage levels. For example, an oil-type furnace transformer transforms a voltage of 110 kV to a voltage of 1.5 kV, an oil-type main transformer transforms a voltage of 110 kV to 0.4 kV, and a dry-type distribution transformer transforms a voltage of 33 kV to 0.4 kV. The power required for such transformers may be approximately 0.4 megawatt up to more than 100 megawatt.

A few problems associated with high-voltage transformers in the given power ranges is that oil insulation is needed at approximately 36 kV for oil-type transformers. For dry-type, large air distances between the upper-voltage winding and the lower-voltage winding are provided with insulation below 36 kV, or a very expensive overall casting using resin material becomes necessary. Known dry insulations may be unsuitable and allow partial discharge at the surface of the insulation under high voltages, which restricts the operation of the transformer or renders the construction impossible.

Presently, there are no known high-voltage transformers in the high power range that are able to operate without oil insulation above 36 kV. Dry-type transformers are built without oil insulation up to a voltage of 36 kV. These are cast-resin transformers in which a casting resin is used for insulation. Additionally, insulating materials that utilize a multi-layered structure are known. However, the multi-layered structure does not have electrically conducting layers of defined potential in combination with insulating layers and semiconducting layers. In addition there are pure dry-type transformers up to 20 kV, however these require very large air distances and thereby add to the expense and size of the transformer.

### SUMMARY OF THE INVENTION

An exemplary transformer includes an upper-voltage winding and a lower-voltage winding for potential separation. An insulation arrangement is disposed between the upper-voltage winding and the lower-voltage winding. The insulation arrangement includes a layer structure having an inner insulation, at least one semiconducting layer adjacent to the inner insulation, and an electrically conducting layer adjacent to the at least one semiconducting layer and having a defined potential applied thereto that is at least about equal to a lower voltage of the lower-voltage winding.

An example insulation arrangement includes a layer structure having an inner insulation, at least one semiconducting layer adjacent to the inner insulation, and an electrically conducting layer adjacent to the at least one semiconducting layer and having a defined potential that is at least about equal to a lower voltage of a transformer lower-voltage winding.

In another aspect, an example transformer includes an upper-voltage winding and a lower-voltage winding for potential separation. An insulation arrangement is disposed between the upper-voltage winding and the lower-voltage winding. The insulation arrangement includes a layer structure having first and second inner insulation layers, first and second semiconducting layers respectively adjacent to the first and second inner insulation layers, a first electrically conducting layer between the upper-voltage winding and the first inner insulation and having a first defined potential, a second electrically conducting layer between the first inner insulation and the second inner insulation and having a second, different defined potential, and a third electrically conducting layer between lower-voltage winding and the second inner insulation and having a third, different defined potential.

### BRIEF DESCRIPTION OF THE DRAWINGS

In the following, the invention will be elucidated in more detail with reference to the figures shown in the drawings which schematically illustrate embodiments and in which

FIG. 1 shows a schematic view of an embodiment of a transformer with an insulation arrangement according to an embodiment of the invention;

FIG. 2 shows a schematic view of an embodiment of a transformer with an insulation arrangement according to another embodiment of the invention;

FIG. 3 shows a schematic cross-sectional view of an exemplary winding operation of the upper-voltage winding of an embodiment of a transformer according to the invention on a winding carrier in the form of a ring core.

### DETAILED DESCRIPTION OF THE PREFERRED EMBODIMENT

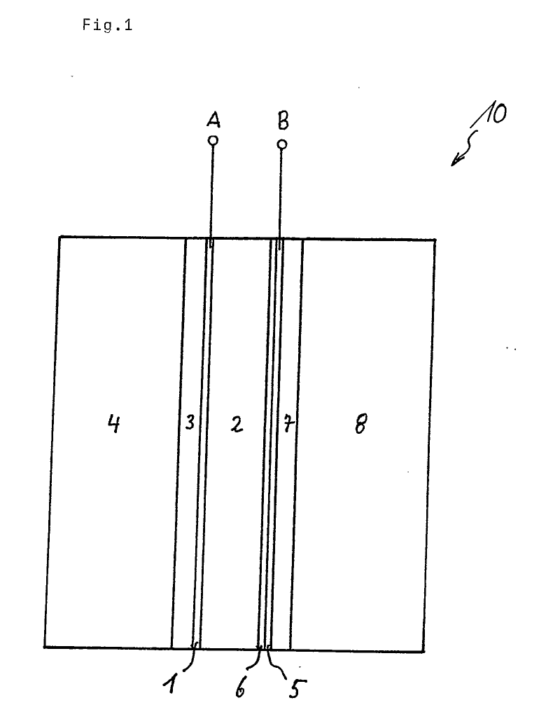

FIG. 1 shows a schematic view of an embodiment of a transformer 10 with an insulation arrangement. For the sake of clarity, the transformer 10 is shown in a schematic manner only. The insulation arrangement is disposed between an upper-voltage winding 4 and a lower-voltage winding 8. It is to be understood that the exemplary insulation arrangement may be adapted from the illustrated example in accordance with the disclosed example, with one variant being shown in FIG. 1.

In this example, the insulation arrangement includes a firmly connected layer structure, but the layer structure may be modified from the disclosed arrangement and may also be extended in modular manner. The disclosed embodiments illustrate a high-voltage transformer in which the advantages of the disclosed concepts may become particularly evident. However, the disclosed examples are applicable to a large variety of transformer types, in particular also in the middle and low voltage ranges.

The insulation arrangement of the transformer 10 is disposed between an upper-voltage winding 4 and a lower-voltage winding 8 for potential separation between an upper voltage and a lower voltage. The insulation arrangement includes a layer structure having an inner insulation 2 and an insulating layer 3 between the upper-voltage winding 4 and a first electrically conducting layer 1. The first electrically conducting layer 1 is at a defined potential A that is equal to the potential of the upper-voltage winding 4, or close to the same within a given tolerance. Thus, there is essentially no potential difference between the electrically conducting layer 1 and the upper-voltage winding 4.

The inner insulation 2 facilitates potential separation and may be formed of silicon or another suitable non-conducting material, for example. A semiconducting layer 6 is located adjacent to the insulating layer 2 and may be formed from a carbon-containing material, for example. Partial discharge on the surface of the inner insulation 2 towards the outside is thus prevented.

A second electrically conducting layer 5 is connected to potential B that is equal to the potential of the lower-voltage winding 8 or, separated from the same by an insulating layer 7, is close to the same within a given tolerance. The insulating layer 7 is between the lower-voltage winding 8 and the electrically conducting layer 5. The layers 3, 1, 2, 6, 5, and 7 (sequentially ordered from left to right in the figure) are firmly connected to each other so as to form a unit.

The layer arrangement may be modified such that the semiconducting layer 6 is disposed on the other side of the inner insulation 2 and thus on the upper-voltage side of the inner insulation 2. In another alternative, another semiconducting layer may be disposed on the upper-voltage side of the inner insulation 2 such that the layer arrangement includes two semiconducting layers. In others examples, the layer arrangement may only include one of the layer pairs 3 and 1 or 5 and 7, and feed only one of the electrically conducting layers 1, 5 from an external voltage source.

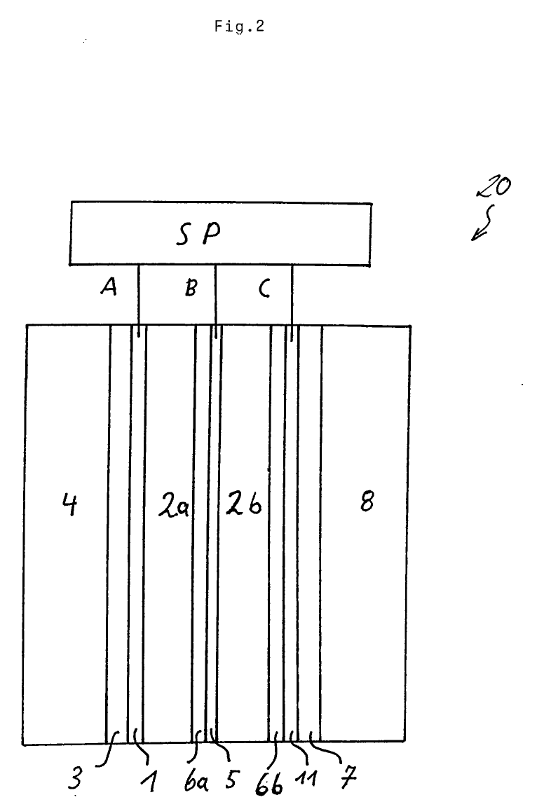

FIG. 2 schematically shows another embodiment of a transformer 20 with an insulation arrangement. In this disclosure, like reference numerals designate like elements where appropriate, and reference numerals with the addition of lettered characters may designate modified element that are understood to incorporate the same features and benefits of the corresponding original elements. In this example, the transformer 20 includes two inner insulations 2a and 2b between the upper-voltage winding 4 and the lower-voltage winding 8 and an external voltage source SP. The voltage source Sp applies a potential A to a first electrically conducting layer 1 that is disposed between the upper-voltage winding 4 and the first inner insulation 2a. The voltage source Sp applies a second defined potential B to a second electrically conducting layer 5 that is disposed between the first inner insulation 2a and the second inner insulation 2b. as the voltage source Sp also applies a third defined potential C to a third electrically conducting layer 11 that is disposed between the lower-voltage winding 8 and the second inner insulation 2b. A first semiconducting layer 6a abuts the first inner insulation 2a, and a second semiconducting layer 6b abuts the second inner insulation 3b.

The illustrated multilayer structure is advantageous in the case of high voltages, such as 60 kV, because the voltage is split into halves within the insulation arrangement. The voltage source SP applies the potential A of 60 kV to the first electrically conducting layer 1, the potential B of 30 kV is applied to the second electrically conducting layer 5, and the potential C of 0.4 kV is applied to the third electrically conducting layer 11. The semiconducting layers 6a and 6b serve for defined potential reduction. The insulating layer 7 forms a separation with respect to the lower-voltage winding 8, and the insulating layer 3 forms a separation with respect to the upper-voltage winding 4 of transformer 20.

The layer arrangement illustrated in of FIG. 2 may also be modified such that the semiconducting layers 6a, 6b are disposed on the upper-voltage side of the inner insulation 2a and 2b. Alternatively, another pair of semiconducting layers 6a, 6b may be provided on the upper-voltage side of the inner insulation 2a and 2b such that there are two sets of semiconducting layers 6a, 6b. In other examples, the layer arrangement may include only one of the layer pairs 3 and 1 or 11 and 7, and to feed only one or selected ones of the electrically conducting layers 1, 5, 11 from an external voltage source. In some cases, the electrically conducting layer 5 may also be omitted.

The layer arrangement illustrated in FIG. 2 may also be provided in modular manner. For example, the third electrically conducting layer 11 is followed by a third inner insulation, followed by a third semiconducting layer and a fourth electrically conducting layer having a fourth defined potential applied thereto that is equal or at least close to the lower voltage with a given tolerance. In this case, the potential C corresponds to a suitable intermediate potential between upper voltage and lower voltage, such as about one third of the total potential difference (in the above numeric example e.g. 20 kV), whereas potential B may then corresponds to about two thirds of the total potential difference between upper voltage and lower voltage (in the above numeric example e.g. 40 kV). The variations described with reference to FIGS. 1 and 2 may be applied in this embodiment as well.

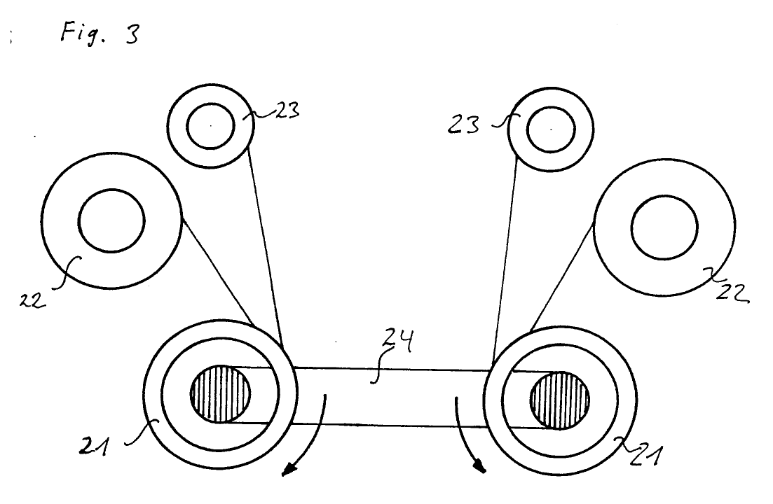

FIG. 3 shows a schematic cross-sectional view of an exemplary winding operation of an upper-voltage winding on a winding carrier in the form of a ring core 24. In this example, two winding carriers 21 have layer structures according to the disclosed examples wound thereon simultaneously. The upper-voltage winding carriers 21 are rotatable about the transformer core 24 and are driven in the direction of the arrows so as to wind the winding material of electrically conducting material (in the instant case a flat aluminum band) 22 and insulating material 23 onto the winding carriers 21. Several upper-voltage segments are connected in series and constitute the upper-voltage winding of the ring core transformer.

The insulation layer structure, including the winding carrier 21 (so-called coil body) for taking up the upper-voltage winding 4, may be prefabricated and split or may be manufactured in integral manner directly around the transformer core 24.

The layer structure may be applied in cylinder form between the upper-voltage winding 4 and the lower-voltage winding 8, and at least an air gap (not shown) for cooling purposes may be present between the upper-voltage winding 4 and the lower-voltage winding 8. The air gap in principle may be disposed between two arbitrary layers of the layer structure, but in general will be disposed relatively close to the upper-voltage and/or lower-voltage winding 4, 8.

The winding carrier 21 may have lateral flanges (not shown) having a frictional or positive, form-fit surface, which facilitates the winding operation.

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A transformer comprising:
an upper-voltage winding and a lower-voltage winding for potential separation; and
an insulation arrangement between the upper-voltage winding and the lower-voltage winding, the insulation arrangement including a layer structure comprising an inner insulation, at least one semiconducting layer adjacent to the inner insulation, and an electrically conducting layer adjacent to the at least one semiconducting layer and having a defined potential applied thereto that is at least about equal to a lower voltage of the lower-voltage winding.

2. The transformer according to claim 1, wherein the at least one semiconducting layer includes a first semiconducting layer adjacent to a first side of the inner insulation and a second semiconducting layer adjacent to a second side of the inner insulation.

3. The transformer according to claim 1, wherein the layer structure includes a second electrically conducting layer having a different, second defined potential applied thereto.

4. The transformer according to claim 3, wherein the second defined potential is at least about equal to an upper voltage of the upper-voltage winding.

5. The transformer according to claim 3, wherein the layer structure includes a first insulating layer between the second electrically conducting layer and the upper-voltage winding.

6. The transformer according to claim 5, wherein the layer structure includes a second insulating layer between the electrically conducting layer and the lower-voltage winding.

7. The transformer according to claim 1, wherein the layer structure forms a winding carrier for taking up the upper-voltage winding.

8. The transformer according to claim 1, wherein the inner insulation includes a first inner insulation having a first one of the at least one first semiconducting layer adjacent thereto, and a second inner insulation having a second one of the at least one semiconducting layer adjacent thereto.

9. The transformer according to claim 8, further comprising a first electrically conducting layer having a first defined potential applied thereto and being disposed between the upper-voltage winding and the first inner insulation, a second electrically conducting layer having a second, different defined potential applied thereto and being disposed between the first inner insulation and the second inner insulation, and a third electrically conducting layer having a third, different defined potential applied thereto and being disposed between lower-voltage winding and the second inner insulation.

10. The transformer according to claim 9, wherein, in sequence within the layer structure, the first electrically conducting layer is followed by the first inner insulation, followed by the first semiconducting layer and the second electrically conducting layer, followed by the second inner insulation, followed by the second semiconducting layer and the third electrically conducting layer.

11. The transformer according to claim 9, wherein the second, different defined potential is equal to about half of a potential difference between the upper-voltage winding and the lower-voltage winding.

12. The transformer according to claim 10, wherein the third electrically conducting layer is followed by a third inner insulation, followed by a third semiconducting layer and a fourth electrically conducting layer having a fourth, different potential applied thereto that is at least about equal to the lower voltage.

13. The transformer according to claim 1, wherein the layer structure forms a winding carrier for taking up the upper-voltage winding, the carrier being rotatable about a transformer core such that and electrically conducting material and an insulating material can be wound thereon.

14. The transformer according to claim 9, further comprising an external voltage source that feeds at least one of the first electrically conducting layer, second electrically conducting layer, or third electrically conducting layers.

15. The transformer according to claim 1, wherein the layer structure forms a winding carrier for taking up the upper-voltage winding, the carrier being prefabricated and split or being manufactured in integral manner directly around a transformer core.

16. The transformer according to claim 1, wherein the layer structure is a cylinder applied between upper-voltage winding and lower-voltage winding, with an air gap between the upper-voltage winding and the lower-voltage winding.

17. An insulation arrangement comprising:
a layer structure comprising an inner insulation, at least one semiconducting layer adjacent to the inner insulation, and an electrically conducting layer adjacent to the at least one semiconducting layer and having a defined potential that is at least about equal to a lower voltage of a transformer lower-voltage winding.

18. A transformer comprising:
an upper-voltage winding and a lower-voltage winding for potential separation; and
an insulation arrangement between the upper-voltage winding and the lower-voltage winding, the insulation arrangement including a layer structure comprising first and second inner insulation layers, first and second semiconducting layers respectively adjacent to the first and second inner insulation layers, a first electrically conducting layer between the upper-voltage winding and the first inner insulation and having a first defined potential, a second electrically conducting layer between the first inner insulation and the second inner insulation and having a second, different defined potential, and a third electrically conducting layer between lower-voltage winding and the second inner insulation and having a third, different defined potential.

19. The transformer according to claim 18, wherein, in sequence within the layer structure, the first electrically conducting layer is followed by the first inner insulation, followed by the first semiconducting layer and the second electrically conducting layer, followed by the second inner insulation, followed by the second semiconducting layer and the third electrically conducting layer.

20. The transformer according to claim 18, wherein the second, different defined potential is equal to about half of a potential difference between the upper-voltage winding and the lower-voltage winding.
